(19) United States
(12) Patent Application Publication
(10) Pub. No.: US 2024/0046597 A1
(43) Pub. Date: Feb. 8, 2024

(54) SYSTEM THAT CALCULATES AVAILABLE SHELF SPACE BASED ON IMAGES PROJECTED ONTO THE SHELF SURFACE

(71) Applicant: ACCEL ROBOTICS CORPORATION, San Diego, CA (US)

(72) Inventors: Marius BUIBAS, San Diego, CA (US); John QUINN, San Diego, CA (US)

(73) Assignee: ACCEL ROBOTICS CORPORATION, San Diego, CA (US)

(21) Appl. No.: 17/879,726

(22) Filed: Aug. 2, 2022

(51) Int. Cl. G06V 10/22; G06V 10/88; G06V 10/25; G06V 10/50; G06T 7/62; G06T 7/70

(52) U.S. Cl. CPC G06V 10/22; G06V 10/88; G06V 10/25; G06V 10/50; G06T 7/62; G06T 7/70

(57) ABSTRACT

A system that analyzes images of a shelf to determine the available shelf space. Camera images of the shelf from multiple viewpoints may be projected onto the shelf surface to remove distortions from camera projections and to align images to a common shelf reference frame. A mask may be calculated from each projected image that identifies regions that match the appearance of the shelf surface. The shelf surface may have a specific pattern to facilitate identification of these regions. A combined mask may be formed as a union of the masks from individual projected image masks. The available shelf space corresponds to the regions in the combined mask. Combining image masks from multiple viewpoints reduces the effect of occlusion of the shelf surface by items on the shelf.

### BACKGROUND OF THE INVENTION

### Field of the Invention

One or more embodiments of the invention are related to the field of image analysis. More particularly, but not by way of limitation, one or more embodiments of the invention enable a system that calculates available shelf space based on images projected onto the shelf surface.

### Description of the Related Art

Organizations that stock or sell items often need to determine how much available space remains on their shelves. This information may be used to determine where to place additional items, and to manage shelf restocking. Typically, this information is determined by performing a manual inventory of the items on each shelf, which is an extremely time-consuming and error-prone process.

In some environments, shelves may be monitored continuously or periodically by cameras. For example, in an automated store or in a fully or partially automated warehouse, cameras may be used to detect when items are taken from or added to shelves. Camera images of shelves may be used in principle to determine the shelf contents, and to derive the available space remaining on a shelf. However, analysis of these images is complicated by factors such as spatial distortions due to camera perspectives and occlusion of shelf space by the items on the shelf. There are no known systems that process shelf images to compensate for these effects.

For at least the limitations described above there is a need for a system that calculates available shelf space based on images projected onto the shelf surface.

### BRIEF SUMMARY OF THE INVENTION

One or more embodiments described in the specification are related to a system that calculates available shelf space based on images projected onto the shelf surface. The system may have a processor coupled to multiple cameras that are each oriented to view the surface of the shelf. The shelf may contain one or more items. The processor may be coupled to a memory that contains the appearance of the shelf surface, which is distinguishable from the appearance of the items. The memory may also contain a shelf surface projection transformation associated with each camera, which maps images from the camera onto the surface of the shelf.

The processor may obtain images of the shelf from the camera and may project these images onto the shelf surface using the associated shelf surface projection transformations associated with the cameras. A visible shelf surface mask may be generated for each projected image that identifies one or more regions in the projected image that match the appearance of the shelf surface. The masks may be combined into a combined mask using a union operation. The available shelf space may then be calculated based on the combined mask.

In one or more embodiments the available space may be calculated as a fraction of the surface area of the shelf. The processor may calculate this fraction by summing the pixel values of the combined visible shelf surface mask and dividing this sum by the total number of pixels in the mask. The processor may also calculate the area of the available space by multiplying the fraction of available space by the area of the shelf surface.

In one or more embodiments the shelf surface projection transformation associated with each camera may include a homography between the image plane of the camera and the shelf surface plane.

In one or more embodiments the appearance of the shelf surface may include repeated copies of a unit pattern, and generation of the visible shelf surface masks may include identifying regions of the projected shelf images that match the unit pattern.

### BRIEF DESCRIPTION OF THE DRAWINGS

The above and other aspects, features and advantages of the invention will be more apparent from the following more particular description thereof, presented in conjunction with the following drawings wherein:

FIG. 1 shows an overview diagram of an illustrative embodiment of the invention, which analyzes images of a shelf taken from different viewpoints to calculate how much of the space on the shelf is available.

FIG. 2 shows a flowchart of illustrative steps performed by a processor to obtain and analyze images to calculate available shelf space.

FIG. 3 shows two illustrative patterns for a shelf surface that may facilitate determination of available shelf space.

FIG. 4 shows illustrative camera images of the shelf of FIG. 1.

FIG. 5 illustrates transformations that map camera images onto the shelf surface.

FIG. 6 illustrates projection of the camera images of FIG. 4 onto the shelf surface, and generation of the visible shelf surface masks from the projected camera images.

FIG. 7 illustrates combining the visible shelf surface masks of FIG. 6 into a combined mask, and calculation of the available shelf space fraction from the combined mask.

### DETAILED DESCRIPTION OF THE INVENTION

A system that calculates available shelf space based on images projected onto the shelf surface will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

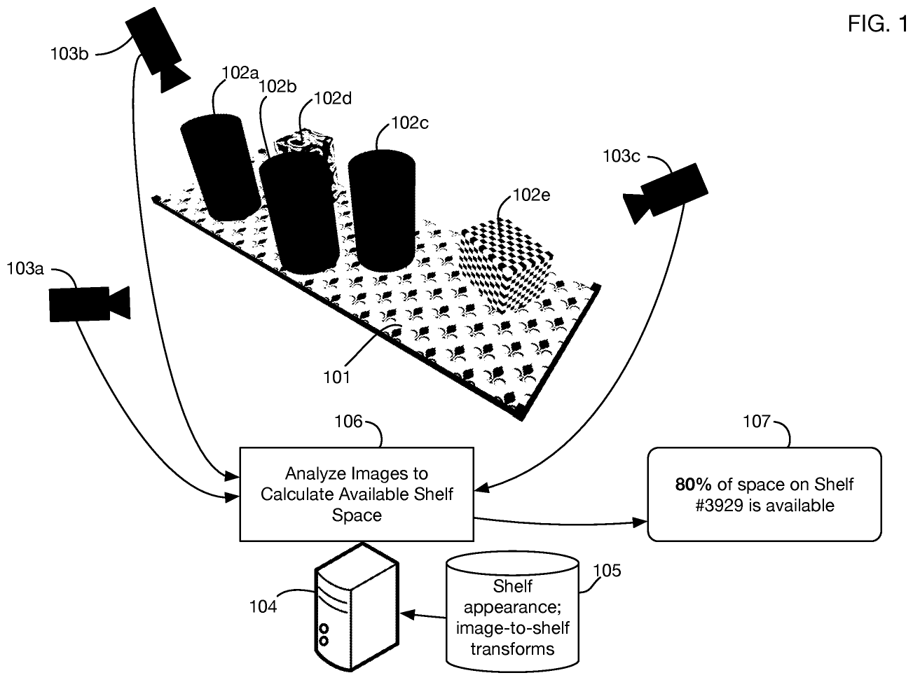

FIG. 1 shows an illustrative embodiment of the invention that calculates the available space on shelf 101. A “shelf” in this application may be any fixture, zone, device, area, case, furniture, container, or similar element that may be used to hold, support, display, or contain one or more items. In the illustrative example shown in FIG. 1, items 102a through 102e are on shelf 101. Items may be of any shape, size, and appearance; for example, items 102a, 102b, and 102c are cylindrical with solid black coloring, and items 102d and 102e are box-shaped with more complex patterns.

In many applications it may be useful to know how much space is available on shelf 101, for example for placement of additional items on the shelf. This information may for example help retailers determine where to place products or when to restock shelves. The illustrative embodiment shown in FIG. 1 calculates the available space on shelf 101 based on analysis of images of the shelf (and the contained items) captured by cameras 103a, 103b, and 103c. One or more embodiments of the invention may analyze images from any number of cameras to determine the available shelf space. Cameras may be oriented to view the shelf from various positions and orientations. Cameras may be integrated into a shelving system, or they may be placed outside the shelf. Any image from any camera that views at least a portion of the shelf may be used in one or more embodiments of the invention.

Analysis 106 of camera images to calculate available shelf space may be performed by a processor 104, or by multiple processors. Processor or processors 104 may be for example, without limitation, a desktop computer, a laptop computer, a notebook computer, a server, a CPU, a GPU, a tablet, a smart phone, an ASIC, or a network of any of these devices. The processor may receive or obtain camera images of shelf 101 from cameras 103a, 103b, and 103c and may perform analyses 106, as describe in detail below, to calculate available shelf space 107 on shelf 106. Calculating available shelf space from camera images involves several challenges. First, each camera image may view only a portion of the available space since items on the shelf may occlude some of the shelf space from each camera. Second, shelf images may be distorted due to camera projections, complicating the calculations of available shelf space. Third, the appearance of the items on the shelves may be highly variable, making it more difficult to identify portions of the shelf that are occupied. The first challenge may be addressed by combining images taken from multiple perspectives, to minimize the impact of occlusion. The second challenge may be addressed by projecting camera images onto the shelf surface, as described below. The third challenge may be addressed by using shelves with a distinctive appearance that can be distinguished from the appearance of items on the shelf. The appearance of the shelf surface may be stored in a database or memory 105 that is connected to processor 104. Transformations to project from camera images onto the shelf surface, or data related to these transformations, may also be stored in memory 105.

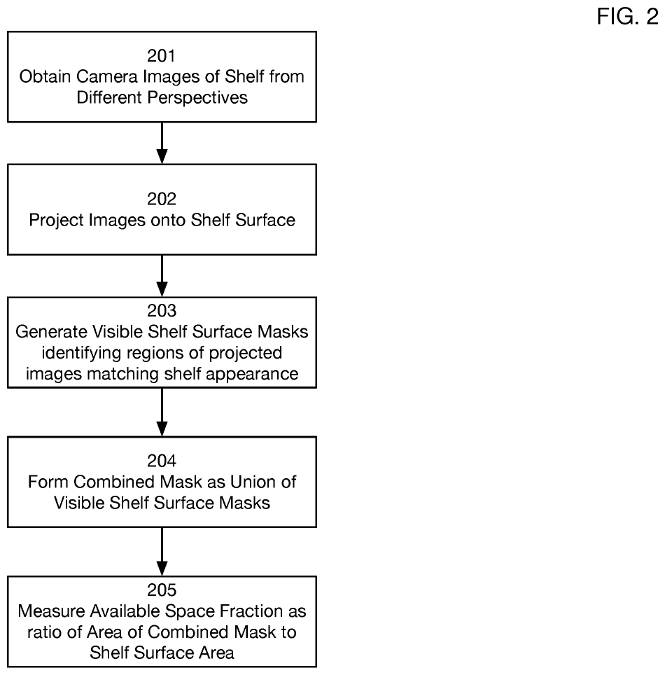

FIG. 2 shows an illustrative sequence of steps that may be performed in one or more embodiments to calculate available shelf space from camera images. These steps may be performed for example by processor or processors 104. One or more embodiments may perform a subset of these steps, may reorder steps, or may perform any additional steps. In step 201, the processor obtains camera images of the shelf (which may contain one or more items) from various cameras that can view the shelf surface from different perspectives. Any number of camera images may be obtained. Some of the camera images may capture only a portion of the shelf. In step 202, the camera images are projected onto the shelf surface, so that the projected images are aligned to a common shelf reference frame and so that perspective distortions are removed. In step 203, a mask is generated for each projected image that identifies the region or regions in the projected image that match the appearance of the shelf surface. In step 204, the masks of the projected images are combined using a union operation (which corresponds to a binary OR). In step 205, the area of the combined mask is calculated and is compared to the total area of the shelf surface to calculate the fraction of the shelf space that is available.

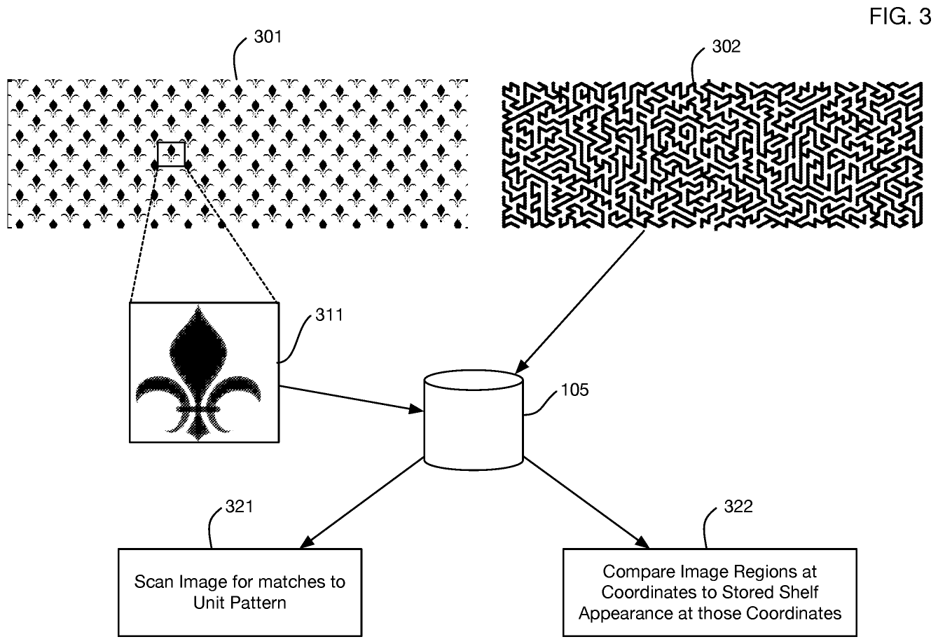

Step 203 generates a mask for regions of each projected image that match the expected appearance of the shelf surface. In one or more embodiments, specific patterns or designs may be placed onto shelf surfaces to facilitate recognition of the available areas of the shelf. FIG. 3 shows two illustrative examples of shelf surface patterns. These examples are illustrative; one or more embodiments may use any type of shelf surface with any appearance. For ease of illustration, the illustrative appearances 301 and 302 are shown in black and white; in applications any shelf appearance features may be used, including colors, shading, shapes, textures, patterns, and icons. Illustrative shelf surface appearance 301 contains a repeating pattern formed from a unit shape 311. Illustrative shelf surface appearance 302 is a nonrepeating pattern. A potential benefit of using a repeating pattern 301 is that the unit pattern 311 can be stored in database 105 and generation of the visible shelf surface mask may perform a scan 321 of the projected image to look for any instances of this unit pattern. This approach also allows the same unit pattern 311 and scanning algorithm 321 to be used with shelves of different shapes and sizes. For a nonrepeating pattern like appearance 302, the entire shelf surface appearance 302 may be stored in database 105, and generation of the mask may for example perform comparisons 322 of projected image regions at specific coordinates to the corresponding regions of pattern 302 at those coordinates.

In one or more embodiments of the invention, step 203 may use for example a machine learning system that is trained to perform segmentation of an image into regions containing the shelf background and regions containing images of items on the shelf. For example, a fully convolutional network may be used to perform this segmentation. The system may be trained using shelf images with various items placed on the shelf in various positions. These training images may be labeled with ground truth masks that indicate the locations of the shelf background. Since the shelf background pattern is consistent across the training images, the machine learning system may be able to learn to find the shelf background quickly with a relatively small number of training images.

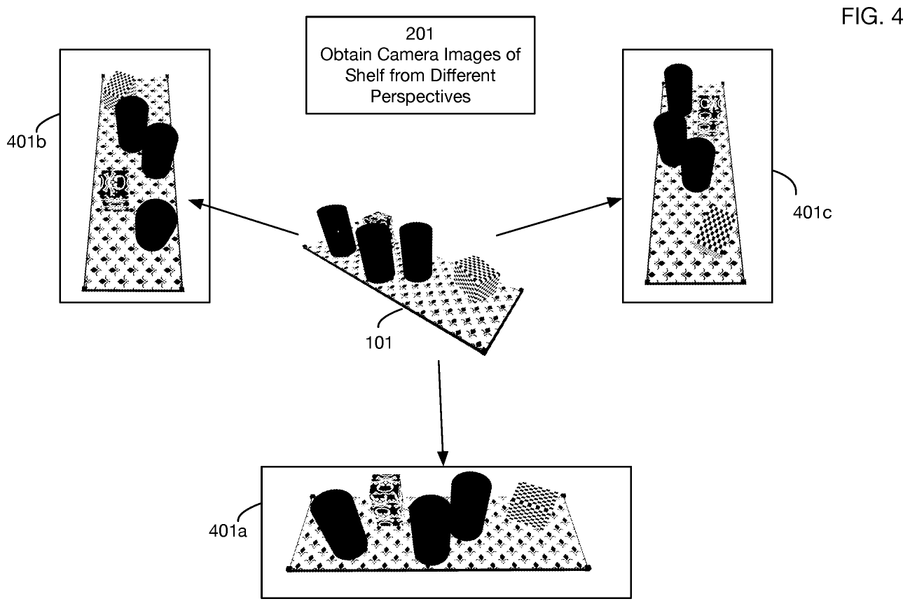

FIGS. 4 through 7 illustrate the steps 201 through 205 for the illustrative shelf 101 of FIG. 1. This illustrative shelf has surface pattern 301. FIG. 4 illustrates the initial step 201 of obtaining camera images 401a, 401b and 401c of the shelf from different viewpoints corresponding to the three cameras 103a, 103b, and 103c. In this example, each image contains a view of the entire shelf; in some embodiments, camera images may view only a portion of the shelf.

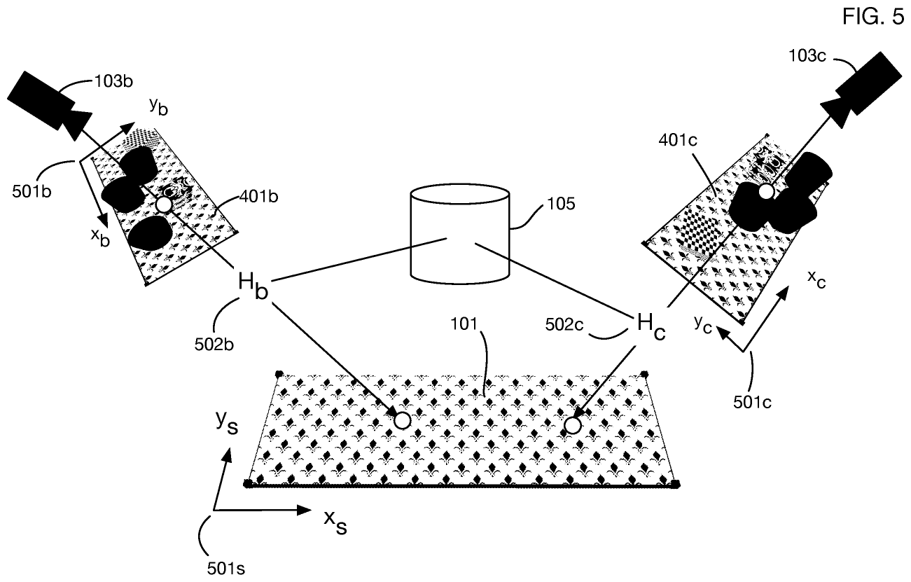

Because camera images 401a, 401b, and 401c are taken from different viewpoints and are subject to perspective effects and other potential distortions, these images cannot be directly compared to the shelf surface appearance, and they cannot be combined directly into a composite image of the shelf. To remove perspective effects and other distortions, images may be reprojected onto the shelf surface, as illustrated in FIG. 5 for images 401b and 401c. Transformation 502b may map points in image reference frame 501b into corresponding points in shelf surface reference frame 501s. Similarly, transformation 502c maps points in image reference frame 501c into shelf surface reference frame 501s. If shelf surface 101 is planar, and if the camera images are simple perspective images without other lens distortions, then these mappings 502b and 502c are homographies. However, any linear or nonlinear transformations may be defined and stored in database 105 for any type of shelf surface, including curved surfaces, and for any type of camera imaging projections. In one or more embodiments the transformations 502b and 502c may be calculated as needed during image analysis, rather than being stored directly in database 105; the database or another memory may include any required camera parameters and shelf surface descriptors to derive the appropriate transformations.

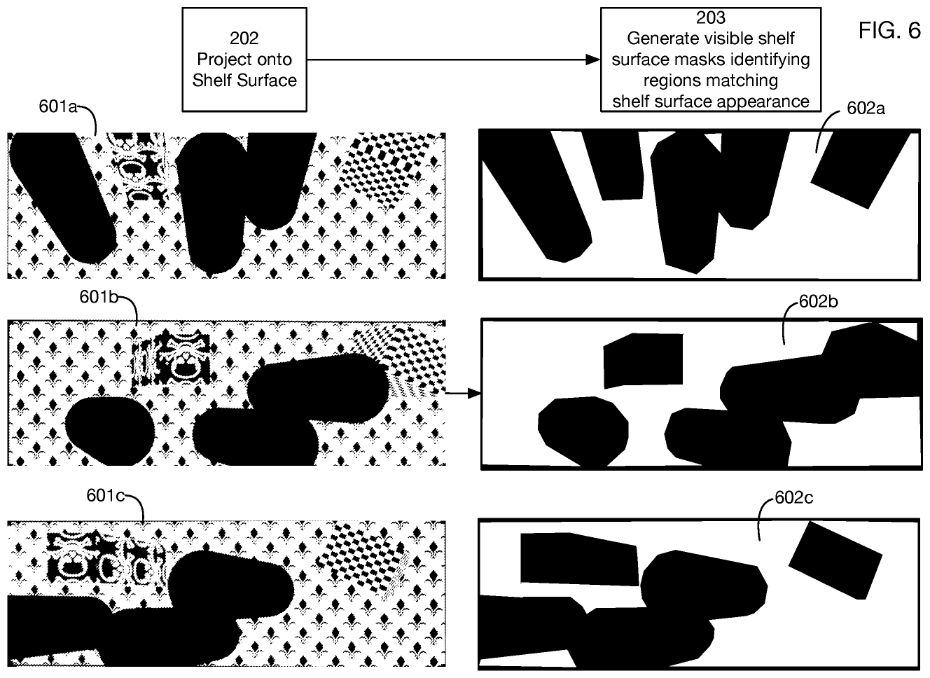

FIG. 6 shows the results of step 202 to apply the shelf surface projection transformations to the camera images 401a through 401c. The resulting projected images 601a through 601c are aligned on a common shelf surface reference frame. Subsequent step 203 generates a mask for each projected image to identify the region or regions of each image with the shelf surface appearance. In this illustrative example, the masks 602a through 602c are binary masks with white values (binary 1) indicating regions that match the shelf surface appearance, and black values (binary 0) indicating regions that do not match the shelf surface appearance. One or more embodiments may use any type of masks with any values to identify the regions that match the shelf surface appearance.

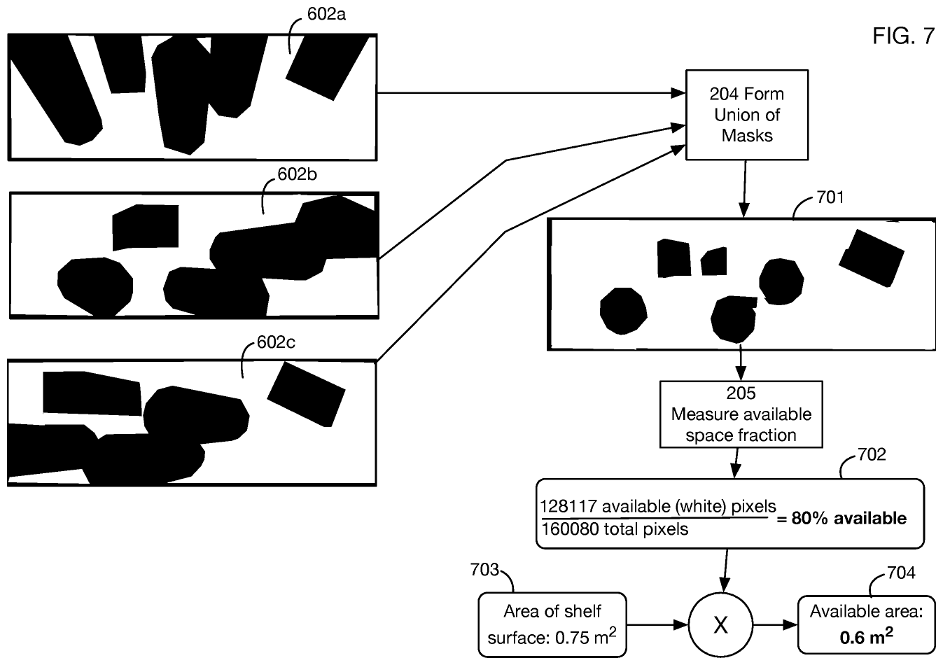

Masks 602a through 602c may then be combined in step 204 to form a combined mask 701, as shown in FIG. 7. This combining operation 204 may be for example a union operation, which may be implemented by performing a pixel-wise binary OR operation on the masks. The resulting combined mask 701 shows regions (in white) where the shelf surface appearance is visible from any of the camera images. Step 205 then measures the area of the white regions (with binary value 1) of the combined mask 701 and compares this area to the total area of the shelf surface. The resulting calculation 702 shows the available shelf space as a fraction of the shelf surface area. The calculation of the available space as a fraction of total space may be performed in pixels, for example by summing the pixel values of the combined mask 701 to obtain the count of the white (binary value 1) pixels, and by dividing this sum by the area of the combined image in pixels. The absolute amount of available space (for example in square meters) 704 may also be calculated by multiplying the fraction 702 times the absolute total shelf surface area 703.

While the invention herein disclosed has been described by means of specific embodiments and applications thereof, numerous modifications and variations could be made thereto by those skilled in the art without departing from the scope of the invention set forth in the claims.

What is claimed is:

1. A system that calculates available shelf space based on images projected onto the shelf surface, comprising:
a processor coupled to a plurality of cameras oriented to view a surface of a shelf configured to hold one or more items;
a memory coupled to said processor, wherein
said memory contains
an appearance of said surface of said shelf, wherein said appearance of said surface of said shelf is distinguishable from said one or more items; and
a shelf surface projection transformation associated with each camera of said plurality of cameras that maps images from said each camera to said surface of said shelf;
wherein said processor is configured to
obtain shelf images from said plurality of cameras;
project said shelf images onto said surface of said shelf to form projected shelf images, using said shelf surface projection transformation associated with each camera of said plurality of cameras;
generate visible shelf surface masks corresponding to said projected shelf images, wherein each visible shelf surface mask of said visible shelf surface masks comprises one or more regions of a corresponding projected shelf image that match said appearance of said surface of said shelf;
generate a combined visible shelf surface mask as a union of said visible shelf surface masks; and,
calculate an available space based on said combined visible shelf surface mask.

2. The system that calculates available shelf space based on images projected onto the shelf surface of claim 1, wherein said available space comprises a fraction of an area of said surface of said shelf.

3. The system that calculates available shelf space based on images projected onto the shelf surface of claim 2, wherein said processor is further configured to calculate said fraction of said area of said surface of said shelf as a sum of pixel values of said combined visible shelf surface mask divided by a number of pixels in said combined visible shelf surface mask.

4. The system that calculates available shelf space based on images projected onto the shelf surface of claim 3, wherein said processor is further configured to calculate an area of said available space as a product of said area of said surface of said shelf and said fraction of said area of said surface of said shelf.

5. The system that calculates available shelf space based on images projected onto the shelf surface of claim 1, wherein said shelf surface projection transformation associated with each camera comprises a homography between an image plane of said each camera and a shelf surface plane.

6. The system that calculates available shelf space based on images projected onto the shelf surface of claim 1, wherein
said appearance of said surface of said shelf comprises repeating copies of a unit pattern; and
said generate visible shelf surface masks comprises identify regions of said projected shelf images that match said unit pattern.
